(19) United States
(12) Patent Application Publication
(10) Pub. No.: US 2017/0161779 A1
(43) Pub. Date: Jun. 8, 2017

(54) APPLYING GUARDRAILS FOR A MULTI-OBJECTIVE ADVERTISEMENT CAMPAIGN AT AN ONLINE SYSTEM

(71) Applicant: Facebook, Inc., Menlo Park, CA (US)

(72) Inventors: Stuart Michael Bowers, Menlo Park, CA (US); Shyamsundar Rajaram, San Francisco, CA (US); Rubinder Singh Sethi, San Francisco, CA (US)

(21) Appl. No.: 14/960,988

(22) Filed: Dec. 7, 2015

(51) Int. Cl. G06Q 30/02

(52) U.S. Cl. CPC G06Q 30/0247; G06Q 30/0255; G06Q 30/0275; G06Q 30/0277

(57) ABSTRACT

An advertising platform calculates bids for advertisements and optimizes bids for a plurality of advertisement objectives, where each objective corresponds to a unique user action. The advertising platform identifies an impression opportunity for an advertisement request, computes a bid amount for presenting the advertisement, and provides the computed bid amount to an advertisement selection process. The bid amount is computed based on expected values of user actions associated with the plurality of advertisement objectives and an expected value multiplier of one or more advertisement objectives, where the expected value multiplier of the one or more objectives represents a bound on a range of values for the expected values of the user actions associated with the one or more objectives.

### BACKGROUND

This disclosure relates generally to online advertising, and more particularly to bidding for online advertisement campaigns with multiple-objectives.

Advertising platforms generate revenue by using targeted advertising. Targeted advertising is more cost-effective than traditional forms of advertising because a targeted advertisement is shown only to a viewing user likely to be interested in the advertisement. Advertising platforms use an auction process to select an advertisement for each impression, i.e., an instance that an advertisement can be shown to the viewing user. The auction process selects an advertisement based on a bid associated with the advertisement.

The value of a bid associated with the advertisement is based on a number of factors, such as the user action rate, or the number of times the advertisement leads to a successful business objective, such as the viewing user clicking on a link associated with an advertisement, or purchasing a product associated with an advertisement (e.g., a conversion). For advertisement campaigns with multiple objectives, where each objective corresponds to a unique user action such as viewing user clicking on a link or purchasing a product, the value of the bid is also based on the user action rate associated with each user action corresponding to each objective of the multiple objectives. When a bid value is computed for an advertisement so as to optimize for the multiple objectives, any variation in the estimation of the bid value component associated with the user action (i.e., objective) that is most valuable to the advertiser can significantly vary the computed bid value. Such a variation in the estimation of the bid component that is most valuable to the advertiser can overwhelm the overall advertisement bid (and budget) for the advertisement campaign.

### SUMMARY

An advertising platform allows advertisers to optimize bids for their advertisements to account for a plurality of objectives of an advertisement campaign, where each objective is associated with a unique user action such as a user clicking on a link associated with an advertisement or purchasing a product in response to viewing the advertisement (e.g., a conversion). For example, an advertiser can have the objective of obtaining clicks on the advertisement from users and also obtaining conversions from users, and the advertiser may be willing to pay different amounts or have different budgets for each objective. The platform receives an advertisement request from an advertiser to present an advertisement to users of an online system. The platform can also receive bidding input from the advertiser (e.g., a budget associated with the advertisement or campaign, or budgets for different objectives) that is used to determine a minimum per unit value (PUV) associated with each user action, the minimum PUV representing an amount that the advertiser is willing to pay per unit of value of a user action of the advertisement. When an impression opportunity to provide advertising to a viewing user of the online system arises, the advertising platform computes a bid amount for the advertisement request and provides the computed bid amount to an advertisement selection process (e.g., an advertisement auction).

The advertising platform computes the bid amount for the advertisement request based on expected values of user actions associated with the plurality of advertisement objectives. For example, the bid amount is computed by determining a product of the expected value of a user action and the minimum PUV of the user action, and then summing up the product for each user action corresponding to the plurality of advertisement objectives. The advertising platform determines the expected values for each user action associated with an advertisement objective as, for example, a product of a user action likelihood and an estimated user action value, where the user action likelihood represents a likelihood of an occurrence of the user action and the estimated user action value represents an estimate of a monetary worth of the user action for the advertiser.

When a bid value is computed for an advertisement to optimize for the plurality of advertisement objectives, any variation in the estimation of the bid value component associated with the user action (i.e., objective) that is most valuable to the advertiser can significantly affect the equation used to compute the multi-objective bid value. One method to avoid having the bid component that is most valuable to the advertiser overwhelm the overall advertisement bid calculation (and budget) for the advertisement campaign is to apply bounds or limits (i.e., guardrails) to at least the bid component associated with the most valuable user action, though the bounds can also be applied across more than one bid component. A guardrail can be applied to a bid component by applying an expected value multiplier to the expected value of the most valuable user action. For the user action with an applicable expected value multiplier, the expected value is a product of the expected value multiplier with the product of the user action likelihood and the estimated user action value. The expected value multiplier for a user action represents a bound on a range of values for the expected value of the user action.

The expected value multiplier is determined based on a comparison between the user action likelihood and a reference likelihood, where the reference likelihood represents an average likelihood of a set of users to perform the user action. The comparison between user action likelihood and a reference likelihood can be based on at least one of: a linear relationship, an exponential relationship, a sigmoid functional relationship, and a percentile relationship.

### BRIEF DESCRIPTION OF THE DRAWINGS

Figure (FIG.) 1 is a block diagram of a system environment for an advertising platform, in accordance with an embodiment.

FIG. 2 is a block diagram of an advertising platform, in accordance with an embodiment.

FIG. 3 is a flow diagram of the bid computing process within the system of FIG. 2, in accordance with an embodiment.

FIG. 4 is a flowchart of a process for calculating a bid for an advertisement with a plurality of objectives based on expected values of user actions associated with the plurality of objectives, in accordance with an embodiment.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

### System Architecture

FIG. 1 is a high level block diagram of a system environment 100 for an advertising platform 140. The system environment 100 shown by FIG. 1 comprises one or more client devices 110, a network 120, an advertiser 130, and the advertising platform 140. In alternative configurations, different and/or additional components may be included in the system environment 100. The embodiments described herein can be adapted to a generic online advertising platform or to an advertising platform that is part of a social networking system.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone, a tablet, or another suitable device. A client device 110 is configured to communicate via the network 120. In one embodiment, a client device 110 executes an application allowing a user of the client device 110 to interact with other client devices 110 and servers, such as the advertising platform 140 or a social networking system. For example, a client device 110 executes a browser application to enable interaction between the client device 110 and the advertising platform 140 via the network 120. In another embodiment, a client device 110 interacts with the advertising platform 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, LTE (Long Term Evolution), code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

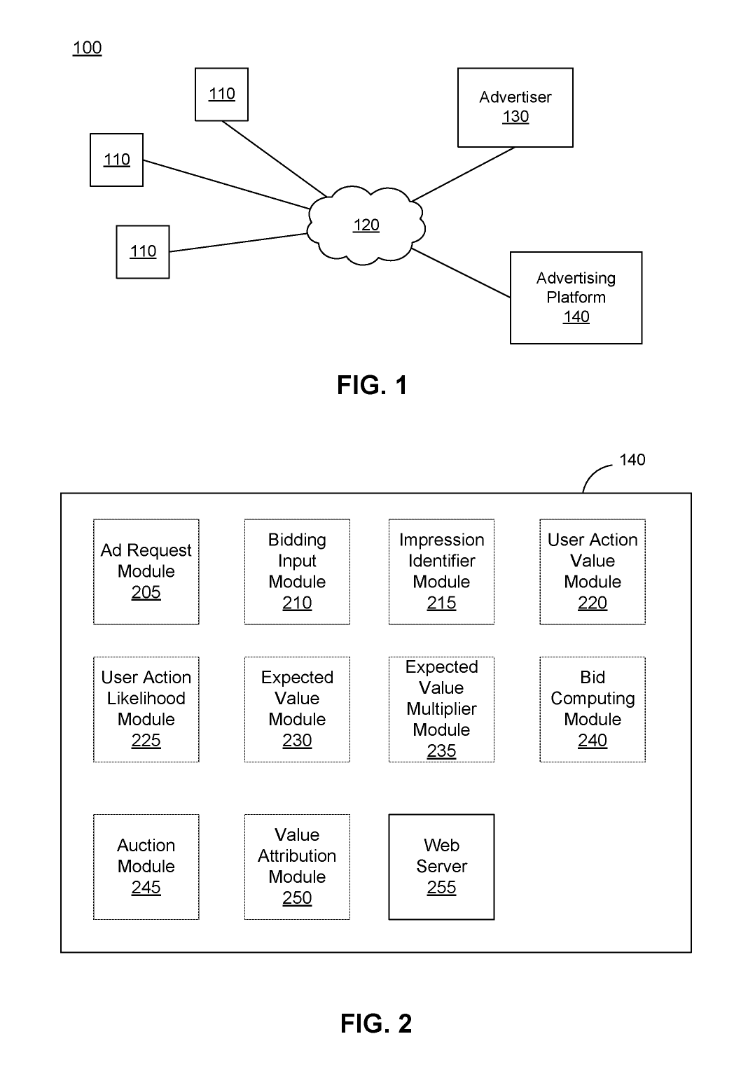

One or more advertisers 130 are coupled to the network 120. The advertiser 130, which may be embodied as a device of an advertising entity (e.g., a server hosted by an online advertising entity, a mobile device used by an advertiser, etc.), communicates with the advertising platform 140, which is further described below in conjunction with FIG. 2. In one embodiment, the advertiser 130 is an application provider communicating information describing applications for execution by a client device 110 or communicating data to client devices 110 for use by an application executing on the client device. An advertiser 130 may communicate information to the advertising platform 140, such as advertisements, content, or information for publication to one or more client devices 110.

FIG. 2 is an example block diagram of an architecture of the advertising platform 140. The advertising platform 140 shown in FIG. 2 includes an ad request module 205, a bidding input module 210, an impression identifier module 215, a user action value module 220, a user action likelihood module 225, an expected value module 230, an expected value multiplier module 235, a bid computing module 240, an auction module 245, a value attribution module 250, and a web server 255. In other embodiments, the advertising platform 140 may include additional, fewer, or different components for various applications. Conventional components such as network interfaces, security functions, load balancers, failover servers, management and network operations consoles, and the like are not shown so as to not obscure the details of the system architecture.

The ad request module 205 receives an advertisement request from an advertiser 130. The advertisement request includes advertisement content. The advertisement content can be text, image, audio, video, or any other suitable data presented to a user. In various embodiments, the advertisement content also includes a landing page specifying a network address to which a viewing user is directed when the advertisement is accessed.

Additionally, the advertisement request may include one or more targeting criteria specified by the advertiser. Targeting criteria included in an advertisement request specify one or more characteristics of viewing users eligible to be presented with content in the advertisement request. For example, targeting criteria are a filter to apply to fields of a user profile and/or actions associated with a viewing user to identify users having user profile information or actions satisfying at least one of the targeting criteria. The user profile and/or actions may be tracked by the advertising platform 140 or by a social networking system connected through the network 120 to the advertising platform 140. Hence, the targeting criteria allow an advertiser to identify groups of users matching specific targeting criteria, simplifying subsequent distribution of content to groups of users.

In embodiments in which the advertising platform 140 is part of a social networking system, the targeting criteria may specify actions or types of connections between a user and another user or object of the social networking system. For example, the targeting criteria identify users that have taken a particular action, such as liking an object, commenting on an object, sharing an object with another user, or any other suitable action. The targeting criteria may also specify interactions between a user and objects performed external to the social networking system, such as objects on a server associated with an advertiser 130. For example, the targeting criteria identify users that have taken a particular action, such as sending a message to another user, installing an application, using the installed application, joining a group, leaving a group, joining an event, generating an event description, purchasing or reviewing a product or service using an online marketplace, requesting information from an advertiser 130, or any other suitable action. Including actions in the targeting criteria allows advertisers to further refine users eligible to be presented with content from an advertisement request. As another example, targeting criteria may identify users having a connection to another user or object or having a particular type of connection to another user or object.

The advertisement request may also include a plurality of advertisement objectives, where each objective is associated with a unique user action. An advertisement objective is an objective that the advertiser intends to achieve with an online advertisement campaign. For example, an advertisement objective includes a number of (or percentage of) users performing certain user action in response to viewing a displayed advertisement. Example user actions (including in social networking contexts) may include clicks, likes, comments, shares, sending a message to another user, installing an application, using the installed application, joining a group, leaving a group, joining an event, generating an event description, purchasing or reviewing a product or service using an online marketplace, requesting information from an advertiser 130, or any other suitable action.

In one embodiment, an advertiser provides a plurality of objectives (i.e., two or more objectives) with an intention to optimize the advertisement campaign for all objectives of the plurality of objectives for a given advertisement budget. For example, when the plurality of objectives include a first objective corresponding to a user action associated with user clicks in response to viewing an advertisement and a second objective corresponding to a user action associated with user conversion (e.g., a user purchasing a product being advertised in the displayed advertisement) in response to viewing the advertisement, the advertiser intends to optimize the advertisement campaign by optimizing a combination of a number (or a percentage) of users who click in response to the displayed advertisement and a number (or a percentage) of users who convert in response to the displayed advertisement.

The bidding input module 210 determines a minimum PUV for user actions associated with the advertisement request. The minimum PUV is an amount that the advertiser 130 is willing to pay per unit value of a user action of the advertisement associated with the advertisement request. The minimum PUV can be a ratio, a percentage, a dollar value, or any other indication of an amount relative to the value of the user action of the advertisement. For example, the minimum PUV can be a ratio that specifies what an advertiser 130 is willing to pay 10¢ per dollar value of a user action or that the advertiser 130 will pay 10% of the value of the user action. In other examples, the minimum PUV is an amount that specifies that the advertiser 130 is willing to pay per the total value of the user action. For example, the minimum PUV can specify that the advertiser 130 will pay $1 for a user action worth $10.

The bidding input module 210 determines the minimum PUV associated with each user action corresponding to an advertisement objective based on a bidding input received from the advertiser 130. The bidding input indicates an amount that the advertiser 130 is willing to spend to get in return the desired action from the user or more generally indicates a value of each action or objective to the advertiser without necessarily providing an amount the advertiser is willing to pay for the objective. In some embodiments, the bidding input is the advertiser's budget (e.g., the advertiser 130 is willing to spend $10,000 for the combination of user actions corresponding to a plurality of advertisement objectives) for the advertisement request. The bidding input module 210 determines the minimum PUV by scaling the advertiser's budget by the value of the user action. The bidding input can depend on the impression opportunity. For example, the bidding input for an impression opportunity that meets all of the advertisement request's targeting criteria may be valued more than an impression opportunity that meets a lower number of targeting criteria. In some embodiments, the bidding input module 210 determines the minimum PUV using a formula, algorithm, or equation provided by the advertiser 130. For example, the advertiser 130 might provide a standard bidding model in which the bid is optimized for the number of user actions and not the value of the user actions, and the bidding input module 210 can determine the minimum PUV based on this bidding input. In this example, the bidding input module 210 might determine the minimum PUV using information such as past history of bidding for this advertiser, past indications by the advertiser of the value of various types of user actions, based on general information provided by the advertiser about user action values for different impression opportunities or information obtained by observing user actions for this advertiser over time, among other data and any combination of these data.

The impression identifier module 215 identifies an impression opportunity to deliver advertising to a viewing user of an online system, such as a social networking system or any other online system that might interact with or include the advertising platform 140. For example, the module 215 can identify an impression opportunity for the advertisement associated with the advertisement request. The impression opportunity is an instance during which the advertising platform 140 can display an advertisement to a viewing user. For example, the impression opportunity can occur when a user accesses a web page with space to display an advertisement. The impression identifier module 215 selects advertisements for the impression opportunity based on the targeting criteria and/or advertisement content associated with various advertisement requests, including the advertisement request received by advertiser 130. In some embodiments, the impression identifier module 215 selects an advertisement for the impression opportunity if the viewing user matches a threshold number of targeting criteria.

The user action value module 220 estimates a value of the user action, herein referred to as the “estimated user action value.” The estimated user action value is a prediction of the monetary worth of a single user action for the advertisement. In one embodiment, this is the estimated user action value for a user action involving a particular viewing user or for a user action involving a particular impression opportunity (since there can be more than one impression opportunity with a given viewing user). The value of a user action associated with an advertisement may differ for different viewing users or across different impression opportunities. For example, a user action associated with an advertisement for a social game application involving a viewing user that is a frequent player of social games might be more valuable than a user action associated with the advertisement involving a viewing user that rarely uses social games, even though the advertiser may make the same amount of money from each user's purchase of the game as a result of the advertisement. Since the game user plays games frequently, this user is much more likely to share this game with others, possibly resulting in multiple additional purchases of the game and more overall value to the advertiser. Similarly, out of two impression opportunities for the game user, user actions associated with certain impression opportunities may be more valuable than others. For example, a user action that occurs for an impression opportunity on a social networking website versus a news website might be more likely to result in the game user more immediately playing the social game and immediately sharing with others that might buy the game.

The estimated user action value typically is the value of the advertised good or service, but it can also be the revenue generated per user action, the profit per user action, the monetary impact of the user action on the advertiser's competitor, or any other value associated with the user action for the advertisement. The advertiser 130 can provide the estimated user action value for the user action value module 220. In some embodiments, the advertiser 130 includes the estimated user action value for the advertisement in the advertisement request. For example, an advertiser 130 may specify in the advertisement request that the user action value is $5 for a $5 sandwich. The estimated user action value can be based on other advertisement-specific information. In other embodiments, the advertising platform 140 determines the estimated user action value automatically or without input from the advertiser 130.

In some embodiments, the user action value module 220 calculates the estimated user action value based on information about the viewing user and/or the advertiser, since as explained above, the estimated user action value may be different for different viewing users. The user action value module 220 can use a statistical formula, a machine learning algorithm, or any other formula to calculate the estimated user action value, and the formula or algorithm used can be provided by the advertiser or set by the user action value module 220. Where the formula or algorithm is set by the user action value module 220, the module 220 may receive the inputs to the formula from the advertiser or may determine the inputs itself.

The formulas used by the user action value module 220 can be a function of user-specific information known by the advertising platform 140. For example, in embodiments in which the advertising platform 140 interfaces with a social networking system, the user action value module 220 receives profile information that describes viewing user characteristics, social connections, and online interactions associated with the viewing user. The user action value module 220 calculates the estimated user action value based on the received profile information. In some embodiments, the estimated user action value can be based on the time of day the advertisement is displayed, the advertisement content, the viewing user's geographic location, or certain characteristics of or information about the viewing user. The user action value module 220 can use information about the advertised product or service known by the advertiser 130 to calculate the estimated user action value. For example, the user action value module 220 can use the price of the advertised good or service or other financial information not provided in the advertisement request to calculate the determined user action value. Other examples of the user action value module 220 use a machine learning algorithm, based on information specific to the viewing user, to determine the estimated user action value.

The user action likelihood module 225 calculates a likelihood or probability of an occurrence of the user action associated with an advertisement objective, herein referred to as the “user action likelihood,” of the user action by the viewing user corresponding to the advertisement objective. The user action likelihood module 225 calculates the user action likelihood based on user-specific information known by the advertising platform 140. In one embodiment, the user action likelihood module 225 receives profile information associated with the viewing user. The profile information can be from the viewing user's profile on a social networking system and may include characteristics of the viewing user, social networking connections of the viewing user, and interactions the viewing user has performed in the social networking system. The user action likelihood module 225 calculates the user action likelihood based on user-specific information known about the viewing user, such as the viewing user's profile information. For example, viewing users with certain characteristics (e.g., users of certain age ranges, certain demographics, in certain locations, having certain likes and dislikes, among other characteristics) might be known to be more likely to click on an advertisement and buy a product based on the click than other users. Another factor that might be considered in by the user action likelihood module 225 is historical information about a given user's clicks on advertisements, since users who click frequently on advertisements might be more likely to click again. Similarly, a user might be more likely to click on advertisements of a certain type (e.g., advertisements with images versus those without, advertisements on a particular topic, advertisements that include social context about friends or social networking connections who may have liked the product, advertisement shown at particular times of day or days of the week, etc.). The user action likelihood is calculated separately for each viewing user or impression opportunity and can be specific to each viewing user or impression opportunity. In one embodiment, the user action likelihood module 225 calculates the user action likelihood for each user action associated with each advertisement objective of the plurality of objectives.

The expected value module 230 calculates the expected value of the user action associated with an advertisement objective, herein referred to as the “expected user action value” of the user action corresponding to the advertisement objective. The expected user action value is the estimated user action value adjusted for the likelihood of the user action. The expected user action value is based on both the estimated user action value and the user action likelihood. In some embodiments, the expected user action value is the product of the user action likelihood and the estimated user action value. For example, the equation to determine the expected value of the user action can be:

V_{expected}=Pᵤₛₑᵣ_{_}_{action}*V_{estimated}

In the above equation, V_{estimated} is the estimated value of the user action Pᵤₛₑᵣ_{_}_{action} is the user action likelihood, and V_{expected} is the expected value of the user action. However, the expected value module 230 can use other equations, formulas, or algorithms based on the estimated value of the user action to calculate the expected value of the user action. In one embodiment, the expected value module 230 calculates the expected value of the user action for each user action associated with each advertisement objective of the plurality of objectives.

The expected value multiplier module 235 calculates an expected value multiplier for a user action associated with an advertisement objective, herein referred to as “expected value multiplier,” of the advertisement objective. The expected value multiplier represents a bound on a range of values for the expected value of the user action associated with the advertisement objective. For example, expected value multiplier is computed to be within a range of values such as [0.8, 1.0], such that when the expected value of the user action determined by the expected value module 230 is multiplied by the expected value multiplier, there is a bound set on the range of values of the expected value of the user action. For example, the equation to determine the bounded range of expected value of the user action can be:

V_{expected}=Pᵤₛₑᵣ_{_}_{action}*V_{estimated}*Vₘᵤₗₜᵢₚₗᵢₑᵣ

In the above equation, Vₘᵤₗₜᵢₚₗᵢₑᵣ is the expected value multiplier. For example, when expected value multiplier has a range of [0.8, 1.0], the bounded range of the expected value of the user action is between greater than or equal to 0.8*V_{expected}, and less than or equal to 1.0*V_{expected}.

The expected value multiplier can be computed for one or more user actions associated with the advertisement request's plurality of objectives. In one embodiment, the expected value multiplier is included for only one user action among the plurality of user actions. For example, the expected value multiplier is computed for the user action that is most valuable to the advertiser 130 among the user actions associated with the plurality of objectives to place a bound on the bid amount associated with that most valuable user action and in turn to place a bound on the bid amount associated with the advertisement request as described further below with reference to bid computing module 240. The expected value multiplier can also be included for more than one of the user actions.

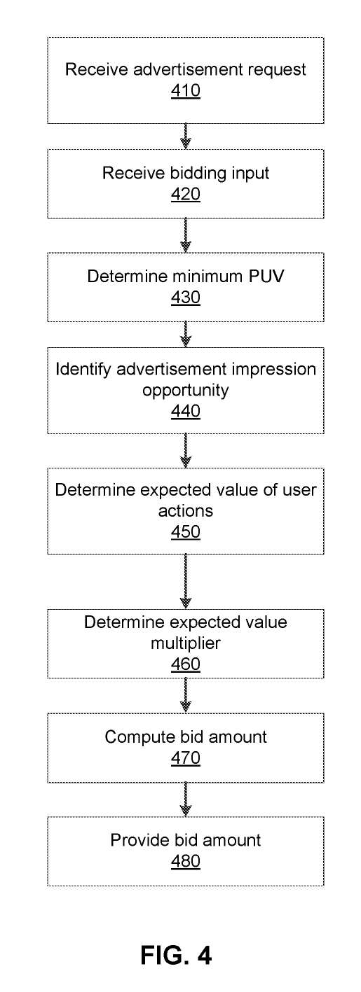

The expected value multiplier can be computed based on various functions that generate a range of bounded values for the expected value of the user action based on some reference data. An example reference bid limiting function is a function that represents a deviation of a user action likelihood when compared with some reference likelihood, where the reference likelihood can be an empirical average likelihood of similar user actions by a set of users. Other example functions relate to probabilistic bid limiting, linear bid limiting, percentile bid limiting, sigmoidal bid limiting, and exponential bid limiting, which are described below in detail with reference to FIG. 4.

The bid computing module 240 computes a bid amount associated with various impression opportunities for the advertisement, where there are a plurality of advertisement objectives. The bid amount is provided for the impression opportunity. In some embodiments, the bid is a paced bid set by the system to pace the advertiser's budget across a period of time such that the entire budget is not immediately spent in the first few minutes of the start of the advertisement campaign. Paced bidding is described in more detail at U.S. application Ser. No. 13/294,094, filed Nov. 10, 2011, which is hereby incorporated by reference herein in its entirety.

The bid amount is based on both the expected user action value and on the minimum PUV associated with the user action. In one embodiment, the bid amount corresponding to advertisement objective of the plurality of advertisement objectives is computed by scaling the expected user action value by the minimum PUV, such as by multiplying the expected user action value by the minimum PUV, where the expected user action and minimum PUV correspond to the particular advertisement objective. Next, the overall bid amount is computed by summing the computed bid amounts that correspond to each advertisement objective of the advertisement request. For example, the equation to determine the overall bid amount can be:

$$Bid = {\sum }_{k = 1}^{n} {V}_{expected\_k} * {ROI}_{k}$$

In the above equation, V_{expected}_{_}ₖ is the expected value of the k^{th} advertisement objective (i.e., k^{th} user action) for an advertisement request with n advertisement objectives (i.e., n user actions) and ROIₖ is the minimum PUV associated with the k^{th} advertisement objective. As discussed above, not all user actions have an expected value multiplier term for computing their expected value. For the one or more user actions that include an expected value multiplier term, the expected value of that user action is given by:

V_{expected}_{_}ₖ=Pᵤₛₑᵣ_{_}_{action}_{_}ₖ*V_{estimated}_{_}ₖ*Vₘᵤₗₜᵢₚₗᵢₑᵣ_{_}ₖ

And for the user actions that don't include an expected value multiplier term, the expected value of those user actions is given by:

V_{expected}_{_}ₖ=Pᵤₛₑᵣ_{_}_{action}_{_}ₖ*V_{estimated}_{_}ₖ

In some embodiments, the bid amount is based on the expected user action value and is not based on the minimum PUV associated with the user action. For example, the bid amount corresponding to each advertisement objective of the plurality of advertisement objectives is computed by the expected user action value and is not based on the minimum PUV. The overall bid amount is computed by summing the computed bid amounts that correspond to each advertisement objective of the advertisement request. For example, the equation to determine the overall bid amount can be:

$$Bid = {\sum }_{k = 1}^{n} {V}_{expected\_k}$$

An example advertisement campaign in which an advertiser may be interested in optimizing three objectives associated with user actions such as obtaining users viewing an advertisement, obtaining clicks on the advertisement, and obtaining conversions from users is discussed. An example equation to compute the overall bid amount is given by:

Bid₃=P_{view|view}*V_{estimated}_{_}_{view}+P_{click|view}*V_{estimated}_{_}_{click}+P_{conv|view}*V_{estimated}_{_}_{conv}

Example estimated values of the user action can be $0.01 for a user view, $0.1 for a user click, and $10 for a conversion by a user. And example probabilities can be P_{view|view}=1, P_{click|view}=0.1, and P_{conv|view}=0.001. For the given example values, the bid₃ is $0.03. The bid component corresponding to the user action of conversion is about 33% of the overall bid amount. Because the probability of a conversion is a small number and the estimated value of conversion is a large number, any variation (e.g., increase) in the conversion probability greatly affects the overall bid amount. For example, if the probability of conversion increases from 0.001 to 0.005, the overall bid amount increases from $0.03 to $0.07, and the conversion bid component increases from about 33% to about 70% of the overall bid amount. In some cases, the increase in the conversion bid component can overwhelm the overall budget for the advertisement campaign. To avoid scenarios where a single bid component overwhelms the overall advertisement budget, guardrails can be applied to that particular bid component. In some embodiments, one or more guardrails can be applied to two or more bid components.

In summary, the computed bid for an advertisement with a plurality of advertisement objectives includes one or more components that are bounded due to the presence of an expected value multiplier for the one or more components. In one embodiment, the expected value multiplier is present in only one component of the computed bid. For example, the expected value multiplier is associated with the user action that is most valuable user action to the advertiser.

The auction module 245 receives the computed bid amount and associates the bid amount with the advertisement and a particular impression opportunity. The advertisement is submitted to an auction or advertisement selection process. The advertising platform 140 uses the auction process to select an advertisement to display to the viewing user. The advertisement selection is based on the bid amount among a variety of other factors that can be used in the advertisement selection (e.g., the viewing user's advertisement preferences, the relationship between the advertisement and other content on the page, level of user interest in the topic of the advertisement, etc.). In embodiments in which the advertising platform is connected to or incorporated in a social network, the advertisement may be displayed on a social networking interface, such as within a newsfeed.

The value attribution module 250 attributes a portion of the expected value of the user action to the advertisement selected by the auction module 245. The value attribution module 250 tracks subsequent actions by the viewing user after the advertising platform 140 provides the advertisement for display to the viewing user or after the user clicks on the advertisement. The value attribution module 250 receives an indication of a user action by the viewing user (e.g., determines that the user purchased the advertised product). Based on the tracked actions, the value attribution module 250 attributes a portion of the expected user action value to the advertisement. The portion of the expected user action value can be a binary number (1=user action attributed to the advertisement|0=user action not attributed to the advertisement), a percentage (e.g., 30% of the expected user action value is attributed to the advertisement), or a dollar value (e.g., $20 is attributed to the advertisement). User action attribution information may be sent to the user action value module 220 to improve the formula or algorithm that calculates the estimated user action value and thus the expected user action value. For example, this information can be used in a machine learning process to improve the ability of the user action value module 220 to determine the estimated user action value for each viewing user or impression opportunity.

The web server 255 links the advertising platform 140 via the network 120 to the one or more client devices 110, as well as to the one or more advertisers 130. The web server 255 serves web pages, as well as other web-related content, such as JAVA®, FLASH®, XML and so forth. The web server 255 may receive and route messages among the advertisers 130, the advertising platform 140, and the client device 110, for example, ad content, messages, or other information. Additionally, the web server 255 may provide application programming interface (API) functionality to send data directly to native client device operating systems, such as IOS®, ANDROID™, WEBOS® or RIM®.

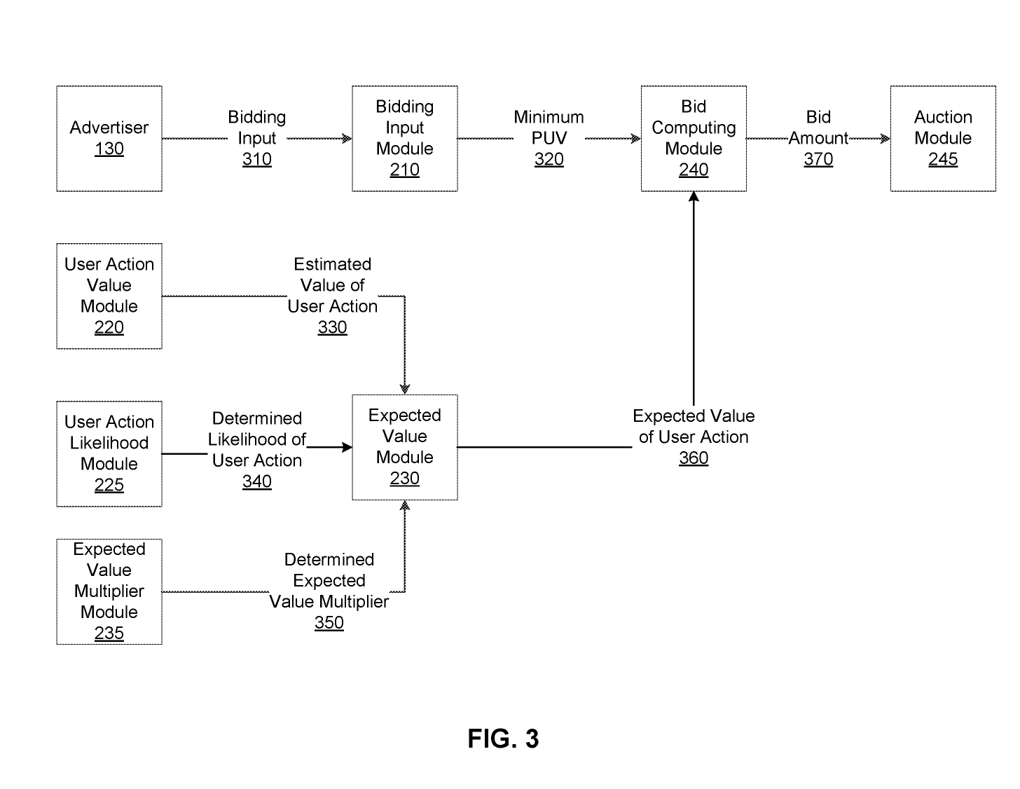

FIG. 3 is a flow diagram of the bid computing process within the system of FIG. 2, in accordance with an embodiment. FIG. 3 illustrates various signals, such as the bidding input 310, minimum PUV 320, estimated user action value 330, determined user action likelihood 340, determined expected value multiplier 350, expected user action value 360, and bid amount 370 being transferred between modules. The signals can be embodied as analog signals, digital signals sent over a logic signal, or objects stored in computer memory.

As described above with reference to FIG. 2, the bid amount 370 is calculated by the bid computing module 240. The bid amount 370 is based on both the minimum PUV 320 and the expected user action value 360 associated with each advertisement objective of the plurality of advertisement objectives. The expected user action value 360, in turn, is based on the estimated user action value 330 from the user action value module 220, the user action likelihood 340 from the user action likelihood module 225, and if applicable, the expected value multiplier 350 from the expected value multiplier module 235. The minimum PUV 320 is determined based on the bidding input 310 received from the advertiser 130.

Method for Calculating Bids for Advertisements with Multiple Objectives

FIG. 4 is a flowchart of a process for calculating a bid for an advertisement with a plurality of objectives based on expected values of user actions associated with the plurality of objectives, in accordance with an embodiment. Unless otherwise noted, the process of FIG. 4 is performed by the advertising platform 140, which may store instructions that cause a processor on the advertising platform 140 to execute the process described in FIG. 4. The process of FIG. 4 may include additional or alternative steps.

The advertising platform 140 receives 410 an advertisement request from the advertiser 130 to present an advertisement to a plurality of users of an online system. The advertisement request includes advertisement content, targeting criteria, and a plurality of advertisement objectives as described above with reference to ad request module 205 of FIG. 2.

The advertising platform 140 receives 420 a bidding input from the advertiser 130. The bidding input indicates how much the advertiser 130 is willing to pay to display the advertisement. The bidding input can be a maximum or minimum value for a bid for the advertisement request, a budget for the advertisement, or a minimum PUV for user actions associated with the plurality of objectives of the advertisement request. In one embodiment, each user action associated with each advertisement objective of the plurality of objectives has a separate minimum PUV. The bidding input can be received from the advertiser 130, e.g., as part of the advertisement request. In some embodiments, in which the advertising platform is connected to a social networking system, the advertising platform 140 determines the bidding input based on tracked interactions of the viewing user in the social networking system and profile information of the viewing user.

The advertising platform 140 determines 430 a minimum PUV based on the bidding input. The minimum PUV is an amount that the advertiser is willing to pay per unit of value of a user action of the advertisement. The minimum PUV can be expressed as a ratio, a percentage, a dollar amount, or any other suitable expression of value. For example, the minimum PUV can indicate the advertiser 130 is willing to pay 25¢ per dollar value of the user action for the advertisement. The minimum PUV can be submitted as part of the advertisement request by the advertiser 130 or can be determined 430 by the advertising platform 140 using a formula, algorithm, or other equation provided by the advertiser 130. The equation may be a function of the targeting criteria for the advertisement and user-specific information about the viewing user.

The advertising platform 140 identifies 440 an impression opportunity to advertise to a viewing user of the plurality of users of the online system. For example, a viewing user may have just refreshed a page or navigated to a new page, and hence there is an opportunity to provide advertising to the viewing user. The advertising platform 140 might also identify 440 that the impression opportunity is one that is appropriate for the advertisement of the advertiser that was received 410, since it may match the targeting criteria of that advertisement request. The advertising platform 140 can identify 440 that the impression opportunity is one that matches the advertisement request by using an affinity score representing the affinity of the viewing user for the advertisement or advertisement request. The affinity score is a measure of the viewing user's affinity for the advertisement associated with the advertisement request and may be based on profile information belonging to the viewing user, such as profile information from a social network. Further description of affinity scores is provided in U.S. Pat. No. 8,402,094, which is hereby referenced in its entirety. Furthermore, the advertising platform 140 can identify 440 that the impression opportunity is a match for the advertisement request based on other factors related to the impression opportunity, such as the time of day of the impression, the web page on which the impression is displayed on, and the placement of the advertisement.

The advertising platform 140 determines 450 an expected value of each user action associated with each advertisement objective for the advertisement that includes a plurality of advertisement objectives. The expected value of the user action can be associated with the value of an advertised product or service, the revenue generated by the user action (e.g., a conversion such as purchasing a product), the profit generated by the user action (e.g., a conversion such as purchasing an online service), the impact of the user action on a competitor of the advertiser 130, or any other value. The expected value of the user action can be provided by the advertiser 130 or determined by the advertising platform 140 using a statistical formula, a machine learning algorithm, or any other relevant function or equation. The advertising platform 140 can use user-specific information known by the advertising platform 140 to calculate the expected value of the user action. For example, if the advertising platform 140 is connected to a social networking system, the advertising platform 140 can use profile information, social connections, or tracked interactions to calculate the expected value of the user action. Furthermore, the advertising platform 140 can use information about the advertised product or service to determine 450 the expected value of the user action. For example, the advertising platform 140 can determine the expected value of the user action based on the price of the advertised good or service. The advertising platform 140 can also take into account the likelihood of the user action when determining 450 the expected user action value.

In one embodiment, the expected value of the user action is computed based on an expected value multiplier that represents a bound on a range of values for the expected value of a user action as described above with reference to bid computing module 240 of FIG. 2. The expected value multiplier can be computed 460 based on various functions that generate a range of bounded values for the expected value of the user action based on some reference data as described above with reference to expected value multiplier module 235 of FIG. 2. An example function is based on a comparison between the user action likelihood and a reference likelihood, where the reference likelihood represents an average likelihood of a set of users for performing the user action. Example functions relate to reference bid limiting, probabilistic bid limiting, linear bid limiting, percentile bid limiting, sigmoidal bid limiting, and exponential bid limiting, which are described below.

A reference bid limiting function is a function that represents a deviation of the user action likelihood when compared with some reference likelihood, where the reference likelihood can be an empirical average likelihood of similar user actions by a set of users. The deviation from reference can be represented by the following equation:

dev_from_ref=(Pᵤₛₑᵣ_{_}_{action|impression}−P_{ref}_{_}ᵣₐₜₑ)/P_{ref}_{_}ᵣₐₜₑ

In the above equation, Pᵤₛₑᵣ_{_}_{action|impression} represents a likelihood of a user action given an impression by the user and P_{ref}_{_}ᵣₐₜₑ represents an empirical average rate for the likelihood of the user action for a set of users. The expected value multiplier can be computed using the dev_from_ref by the following equation:

Vₘᵤₗₜᵢₚₗᵢₑᵣ=1.0+max_bid_change*dev_from_ref

In the above equation, max_bid_change represents an amount of bounding that is intended for the expected value of the user action. For example, if the expected value of the user action is to be bounded by 20% (i.e., would not increase by more than 20%), max_bid_change would be set to 0.2, such that the expected value multiplier is always within the range [1.0, 1.2].

In one embodiment, expected value multiplier can be computed using the following equation:

Vₘᵤₗₜᵢₚₗᵢₑᵣ=base_bid_percent+max_bid_change*dev_from_ref

In the above equation, base_bid_percent is chosen such that base_bid_percent+max_bid_change=1. Such a condition would ensure that the maximum possible value for the expected value multiplier is 1.0 and further that expected value of the user action is no larger than Pᵤₛₑᵣ_{_}_{action}*V_{estimated}. In other words, the expected value of the user action is bounded by the expected value multiplier such that the expected value is always less than or equal to Pᵤₛₑᵣ_{_}_{action}*V_{estimated}. For example, when base_bid_percent=0.8, then max_bid_change=0.2 and the range of values for the expected value multiplier is [0.8, 1.0]. The above equation to limit the expected value of the user action to no larger than Pᵤₛₑᵣ_{_}_{action}*V_{estimated} can also be applied to other functions that implement the expected value multiplier, and is not described here to avoid repetition.

A probabilistic bid limiting function is a function that places a bound on the expected value of the user action based on whether the user action likelihood is above a threshold likelihood (e.g., 1 when above the threshold and 0 when not), where the threshold likelihood can be an empirical average likelihood of similar user actions by a set of users. The expected value multiplier using the probabilistic bid limiting function can be computed using by the following equation:

Vₘᵤₗₜᵢₚₗᵢₑᵣ=1.0+max_bid_change*I[P_{(user action|impression)}>P_{threshold}]

In the above equation, I[Pᵤₛₑᵣ_{_}_{action|impression}>P_{threshold}] represents whether the user action likelihood is greater than the threshold likelihood by returning 1 if greater and 0 if not. The probabilistic bid limiting function essentially indicates that if the given user is of high value for a particular user action (i.e., as indicated by the user's I[Pᵤₛₑᵣ_{_}_{action|impression}>P_{threshold}]=1), the bid component associated with the user action is increased/modified by a constant max_bid_change percent, and if the user is not of high value (i.e., as indicated by the user's I[Pᵤₛₑᵣ_{_}_{action|impression}>P_{threshold}]=0), the bid component is not changed. The key point here is that a bound is placed on the change of the expected value of the user (and in turn the total bid amount) by using the expected value multiplier.

A linear bid limiting function is a function that is similar to the probabilistic bid limiting described above in that it places a bound on the expected value of the user action based on whether the user action likelihood is above a threshold likelihood, but while the probabilistic bid limiting function does not change the bid amount when the user action likelihood is below a threshold likelihood, the linear bid limiting function does change (e.g., increase) the expected value of the user action by a small amount when the when the user action likelihood is equal to or even below a threshold likelihood. The expected value multiplier using the linear bid limiting function can be computed using by the following equation:

Vₘᵤₗₜᵢₚₗᵢₑᵣ=1.0+max_bid_change*usage_value

In the above equation, usage_value is computed using the following equation:

usage_value=Pᵤₛₑᵣ_{_}_{action|impression}/(c*P_{threshold})

In the above equation, c is a constant integer, and Pᵤₛₑᵣ_{_}_{action|impression} and P_{threshold} are same as described above with reference to probabilistic bid limiting function. Here, the usage_value is bounded to the rage [0, 1] such that when Pᵤₛₑᵣ_{_}_{action|impression}>c*P_{threshold}, usage_value and the associated expected value of the user action will not change any more.

A percentile bid limiting function is a function that is similar to the linear bid limiting described above but instead of a linear relationship between the multiplier and user action likelihood the percentile bid limiting function represents a percentile relationship. The expected value multiplier is computed by determining a percentile for the user for performing the user action based on the determined user action likelihood in comparison with a threshold likelihood. The expected value multiplier using the percentile bid limiting function can be computed using by the following equation:

Vₘᵤₗₜᵢₚₗᵢₑᵣ=1.0+max_bid_change*cdf(P_{(user action|impression)})

In the above equation, cdf represents a cumulative distribution function that can be used to compute the percentile of the user action likelihood for a specific user action. As the percentile value would always be within the range [0, 1], the multiplier and the bid component are bounded.

A sigmoidal bid limiting function is a function that limits the bid in a sublinear manner with respect to the user action likelihood. The expected value multiplier using the sigmoidal bid limiting function can be computed using by the following equation:

Vₘᵤₗₜᵢₚₗᵢₑᵣ=1.0+max_bid_change*sigmoid(a*[Pᵤₛₑᵣ_{_}_{action|impression}/P_{threshold}−c])

In the above equation, a controls how aggressively the bid limiting (e.g., boosting or decreasing) is skewed towards 0 or 1. For example, the higher a is, the more aggressive the skewing would be towards 0 or 1. In an extreme case when a is large enough, the computer multiplier value based on the sigmoidal bid limiting function would approach that of the multiplier computed based on the probabilistic bid limiting function described above. In the above equation, c controls at what value Pᵤₛₑᵣ_{_}_{action|impression}/P_{threshold} the sigmoid function would be at the mid-point of the range [0, 1], i.e., 0.5.

A exponential bid limiting function is a function that computes the expected value multiplier such that a unit increase in the user action likelihood results in a proportional increase in the expected value for that user action. The expected value multiplier using the exponential bid limiting function can be computed using by the following equation:

if Pᵤₛₑᵣ_{_}_{action|impression}≧P_{threshold}:

$${V}_{multiplier} = 1.0 + max\_bid \_change * ( 1 - {e}^{( - \frac{{P}_{( user action \vert impression )}}{{P}_{threshold}} )} )$$

else:

Vₘᵤₗₜᵢₚₗᵢₑᵣ=1.0

After computing 450 the expected values of user actions for all user actions associated with the plurality of objectives of the advertisement request, and after computing 460 any applicable expected value multipliers for one or more appropriate user actions, the advertising platform 140 computes 470 a bid amount.

In one embodiment with two advertisement objectives such as, user clicks given an impression and user conversion given an impression, the computed bid 370 is given by the following equation:

Bid=V_{expected}_{_}_{click}*PUV_{click}+V_{expected}_{_}_{conversion}*PUV_{conversion},

where

V_{expected}_{_}_{click}=P_{(click|impression)}*V_{estimated}_{_}_{click},

and

V_{expected}_{_}_{conversion}=P_{(conversion|impression)}*V_{estimated}_{_}_{conversion}*Vₘᵤₗₜᵢₚₗᵢₑᵣ_{_}_{conversion}

In the above equation, a conversion is more valuable than click and accordingly an expected value multiplier is computed and applied to the expected value of the conversion and not for that of the click.

The advertising platform 140 provides 480 the bid amount to an advertisement selection process. The advertisement selection process can be an advertising auction performed by the advertising platform 140 or performed by another system. The bid amount is provided with the advertisement request to the advertising auction. Based on the bid amounts of the provided advertisement requests, the advertising platform 140 selects an advertisement to provide for display to the viewing user.

The advertising platform 140 may track actions by the viewing user after providing the viewing user with the selected advertisement. While tracking the actions of the viewing user, the advertising platform can receive an indication that the advertisement user action occurred. The indication of the user action can be any tracked action by the viewing user, such as following a link, making a purchase, viewing an advertisement, visiting a landing page, or any other relevant action. Based on the tracked actions by the viewing user, the advertising platform 140 attributes a portion of the expected user action value to the advertisement. The advertising platform 140 can use any statistical formula, machine learning algorithm, or other apparent function to calculate the attributed portion of the expected value of the user action.

### ADDITIONAL CONSIDERATIONS

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
receiving from an advertiser an advertisement request to present an advertisement to a plurality of users of an online system, the advertisement request comprising a plurality of advertisement objectives, each advertisement objective associated with a unique user action;
identifying an impression opportunity to deliver the advertisement to a viewing user of the plurality of users of the online system;
determining, for each of the advertisement objectives, an expected value of a user action associated with the advertisement objective for the impression opportunity;
determining an expected value multiplier associated with a first advertisement objective of the plurality of advertisement objectives, the expected value multiplier representing a bound on a range of values for the expected value of a user action associated with the first advertisement objective;
computing, by a processor, a bid amount for providing the advertisement for the impression opportunity based on the determined expected values of user actions associated with the plurality of advertisement objectives including the user action associated with the first advertisement objective and the determined expected value multiplier of the first advertisement objective; and
providing the computed bid amount for the advertisement to an advertisement selection process.

2. The computer-implemented method of claim 1, wherein the computed bid amount is further based on a minimum per unit value (PUV) associated with each user action, the minimum PUV representing an amount that the advertiser is willing to pay per unit of value of a user action of the advertisement.

3. The computer-implemented method of claim 2, wherein the bid amount comprises a plurality of bid amount components, each bid amount component corresponding to each user action, each bid amount component computed as a product of the determined expected value of the user action and the minimum PUV of the user action.

4. The computer-implemented method of claim 3, wherein the bid amount is computed by summing the plurality of bid amount components.

5. The computer-implemented method of claim 3, wherein the bid amount component corresponding to the first advertisement objective is further computed by multiplying the determined expected value of the user action and the minimum PUV of the user action with expected value multiplier corresponding to the first advertisement objective.

6. The computer-implemented method of claim 1, wherein the first advertisement objective of the plurality of advertisement objectives corresponds to a user action that is most valuable to the advertiser.

7. The computer-implemented method of claim 1, wherein each expected value associated with each advertisement objective of the plurality of advertisement objectives is determined as a product of a user action likelihood associated with the advertisement objective and an estimated user action value associated with the advertisement objective, the user action likelihood representing a likelihood of an occurrence of the user action and the estimated user action value representing an estimate of a monetary worth of the user action for the advertiser.

8. The computer-implemented method of claim 7, wherein the user action likelihood is determined based on the viewing user's profile information and data associated with the viewing user's past actions.

9. The computer-implemented method of claim 7, wherein the expected value multiplier is determined based on a comparison between the user action likelihood and a reference likelihood, the reference likelihood representing an average likelihood of a set of users for performing the user action.

10. The computer-implemented method of claim 9, wherein the comparison between the user action likelihood and the reference likelihood is based on at least one of: a linear relationship, an exponential relationship, a sigmoid functional relationship, and a percentile relationship.

11. The computer-implemented method of claim 1, wherein the user action is selected from user actions comprising: clicks, likes, comments, shares, sending a message to another user, installing an application, using the installed application, joining a group, leaving a group, joining an event, generating an event description, purchasing or reviewing a product or service using an online marketplace, requesting information from the advertiser.

12. A computer program product comprising a non-transitory computer-readable storage medium having instructions encoded thereon that, when executed by a processor, cause the processor to:
receive from an advertiser an advertisement request to present an advertisement to a plurality of users of an online system, the advertisement request comprising a plurality of advertisement objectives, each advertisement objective associated with a unique user action;
identify an impression opportunity to deliver the advertisement to a viewing user of the plurality of users of the online system;
determine, for each of the advertisement objectives, an expected value of a user action associated with the advertisement objective for the impression opportunity;
determine an expected value multiplier associated with a first advertisement objective of the plurality of advertisement objectives, the expected value multiplier representing a bound on a range of values for the expected value of a user action associated with the first advertisement objective;
compute, by a processor, a bid amount for providing the advertisement for the impression opportunity based on the determined expected values of user actions associated with the plurality of advertisement objectives including the user action associated with the first advertisement objective and the determined expected value multiplier of the first advertisement objective; and
provide the computed bid amount for the advertisement to an advertisement selection process.

13. The computer program product of claim 12, wherein the computed bid amount is further based on a minimum per unit value (PUV) associated with each user action, the minimum PUV representing an amount that the advertiser is willing to pay per unit of value of a user action of the advertisement.

14. The computer program product of claim 13, wherein the bid amount comprises a plurality of bid amount components, each bid amount component corresponding to each user action, each bid amount component computed as a product of the determined expected value of the user action and the minimum PUV of the user action.

15. The computer program product of claim 14, wherein the bid amount is computed by summing the plurality of bid amount components.

16. The computer program product of claim 14, wherein the bid amount component corresponding to the first advertisement objective is further computed by multiplying the determined expected value of the user action and the minimum PUV of the user action with expected value multiplier corresponding to the first advertisement objective.

17. The computer program product of claim 12, wherein the first advertisement objective of the plurality of advertisement objectives corresponds to a user action that is most valuable to the advertiser.

18. The computer program product of claim 12, wherein each expected value associated with each advertisement objective of the plurality of advertisement objectives is determined as a product of a user action likelihood associated with the advertisement objective and an estimated user action value associated with the advertisement objective, the user action likelihood representing a likelihood of an occurrence of the user action and the estimated user action value representing an estimate of a monetary worth of the user action for the advertiser.

19. The computer program product of claim 18, wherein the expected value multiplier is determined based on a comparison between the user action likelihood and a reference likelihood, the reference likelihood representing an average likelihood of a set of users for performing the user action.

20. A system comprising:
a processor; and
a non-transitory computer-readable memory comprising instructions that when executed by the processor cause the processor to:
receive from an advertiser an advertisement request to present an advertisement to a plurality of users of an online system, the advertisement request comprising a plurality of advertisement objectives, each advertisement objective associated with a unique user action;
identify an impression opportunity to deliver the advertisement to a viewing user of the plurality of users of the online system;
determine, for each of the advertisement objectives, an expected value of a user action associated with the advertisement objective for the impression opportunity;
determine an expected value multiplier associated with a first advertisement objective of the plurality of advertisement objectives, the expected value multiplier representing a bound on a range of values for the expected value of a user action associated with the first advertisement objective;
compute, by the processor, a bid amount for providing the advertisement for the impression opportunity based on the determined expected values of user actions associated with the plurality of advertisement objectives including the user action associated with the first advertisement objective and the determined expected value multiplier of the first advertisement objective; and
provide the computed bid amount for the advertisement to an advertisement selection process.
